(19) United States
(12) Patent Application Publication
(10) Pub. No.: US 2012/0293296 A1
(43) Pub. Date: Nov. 22, 2012

(54) MANUAL RESET THERMOSTAT WITH CONTACT RETAINING SPRING

(75) Inventors: Senthilkumar MK, Bangalore (IN); Chandrashekar Srinivas, Bangalore (IN); Rajesh Narayanan, Bangalore (IN); Phaneendra Govindasetty Tirumani, Bangalore (IN); Balaji K. Krishnaswamy, Bangalore (IN)

(73) Assignee: HONEYWELL INTERNATIONAL INC., Morristown, NJ (US)

(21) Appl. No.: 13/109,815

(22) Filed: May 17, 2011

(51) Int. Cl. H01H 37/74

(52) U.S. Cl. 337/342; 337/298

(57) ABSTRACT

A thermostat includes a temperature sensitive element that is responsive to temperature variations to selectively move between at least a first position and a second position. The transfer pin is movable with the temperature sensitive element and is configured, upon movement of the temperature sensitive element from the first position to the second position, to supply a force to a switch that moves the switch from a first switch position to a second switch position. A spring is coupled to the switch and is configured to selectively supply at least a first retainer force to the switch that, when the switch is in the second switch position, retains the switch in the second switch position when the temperature sensitive element moves from the second position back to the first position.

### TECHNICAL FIELD

The present invention generally relates to thermostats, and more particularly relates to a manually resettable thermostat with a spring that retains a switch contact in an open position.

### BACKGROUND

Many thermostats include a temperature sensitive element, such as a bimetallic element, that switches between two stable positions in response to temperature variations. For example, the bimetallic element may be configured to switch (or “snap”) from a first position to a second position when its temperature increases above a temperature set value, and subsequently move from the second position back to the first position when its temperature decreases below a temperature reset value. In many instances, the bimetallic element operates, either directly or indirectly, a switch element. The switch element in turn causes an external device to be either energized or de-energized, depending upon the configuration of the switch.

In some implementations, the temperature differential between the temperature set value and the temperature reset value can be relatively large. Because of this relatively large temperature differential, presently known bimetallic elements may switch at a temperature reset value too far above the desired reset temperature value.

Hence, there is a need for a thermostat that can be implemented with a presently known bimetallic element, and that will not automatically reset at a temperature too far above the reset temperature value. The present invention addresses at least this need.

### BRIEF SUMMARY

In one embodiment, a thermostat includes a housing, a temperature sensitive element, a switch, a transfer pin, and a spring. The temperature sensitive element is disposed within the housing and is responsive to temperature variations to selectively move between at least a first position and a second position. The switch is disposed within the housing and is movable between a first switch position and a second switch position. The transfer pin is disposed between the temperature sensitive element and the switch and is movable with the temperature sensitive element. The transfer pin is configured, upon movement of the temperature sensitive element from the first position to the second position, to supply a force to the switch that moves the switch from the first switch position to the second switch position. The spring is coupled to the switch and is configured to selectively supply at least a first retainer force to the switch when the switch is in the second switch position. The first retainer force retains the switch in the second switch position when the temperature sensitive element moves from the second position back to the first position.

In another embodiment, a thermostat includes a housing, a reset pin, a temperature sensitive element, a switch, a transfer pin, and a C-spring. The reset pin is disposed in, and extends from, the housing, and is movable between a first pin position and a second pin position. The temperature sensitive element is disposed within the housing and is responsive to temperature variations to selectively move between at least a first position and a second position. The switch is disposed within the housing and includes a fixed contact and a movable contact. The movable contact is movable between a closed position, in which the movable contact is electrically connected to the fixed contact, and an open position, in which the movable contact is electrically isolated from the fixed contact. The transfer pin is disposed between the temperature sensitive element and the switch and is movable with the temperature sensitive element. The transfer pin is configured, upon movement of the temperature sensitive element from the first position to the second position, to supply a force to the movable contact that moves the movable contact from the closed position to the open position. The C-spring is coupled to the movable contact and is configured to selectively supply at least a first retainer force to the movable contact when the movable contact is in the open position. The first retainer force retains the movable contact in the open position when the temperature sensitive element moves from the second position back to the first position. The reset pin is moved from the first pin position to the second pin position when the switch moves from the closed position to the open position, and is moved from the second pin position to the first pin position upon receipt of an external reset force.

In yet another embodiment, a thermostat includes a housing, a reset pin, a bimetallic element, a switch, a transfer pin, and a C-spring. The reset pin is disposed in, and extends from, the housing, and is movable between a first pin position and a second pin position. The bimetallic element is disposed within the housing and is responsive to temperature variations to selectively move between at least a first position and a second position. The switch is disposed within the housing and movable between a first switch position and a second switch position. The transfer pin is disposed between the temperature sensitive element and the switch and is movable with the temperature sensitive element. The transfer pin is configured, upon movement of the temperature sensitive element from the first position to the second position, to supply a force to the switch that moves the switch from the first switch position to the second switch position. The C-spring is coupled to the switch, and is configured to selectively supply at least a first retainer force to the switch when the switch is in the second switch position. The first retainer force retains the switch in the second switch position when the temperature sensitive element moves from the second position back to the first position. The reset pin is moved from the first pin position to the second pin position when the switch moves from the closed position to the open position, and is moved from the second pin position to the first pin position upon receipt of an external reset force.

Furthermore, other desirable features and characteristics of the thermostat will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 depicts a cross section view of an embodiment of a thermostat in a first state;

FIG. 2 depicts the cross section view of the thermostat of FIG. 1 with the thermostat in a second state; and

FIG. 3 depicts the cross section view of the thermostat of FIG. 1 with the thermostat in a third state.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

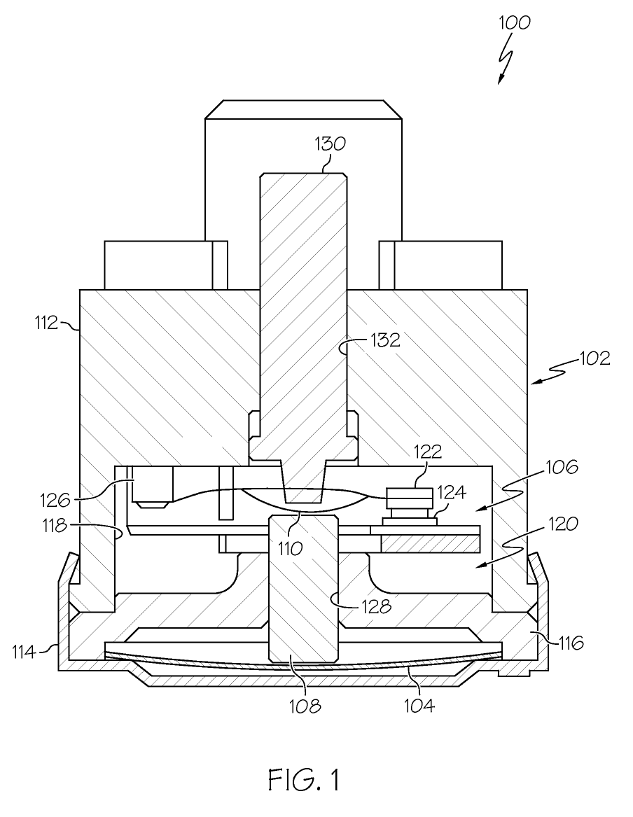

Referring to FIG. 1, a cross section view of one exemplary embodiment of a manual reset thermostat is depicted. The thermostat 100 includes a housing 102, a temperature sensitive element 104, a switch 106, a transfer pin 108, and a spring 110. The housing 102 may be variously configured and implemented, but in the depicted embodiment the housing 102 includes a base 112, an end cap 114, and a retainer 116. The base 112 includes an inner surface 118 that defines an inner volume 120. The end cap 114 is coupled to the base 112 and encloses the inner volume 120. The retainer 116 is disposed between the base 112 and the end cap 114 and, together with the end cap 114, retains the temperature sensitive element 104 within the housing 102.

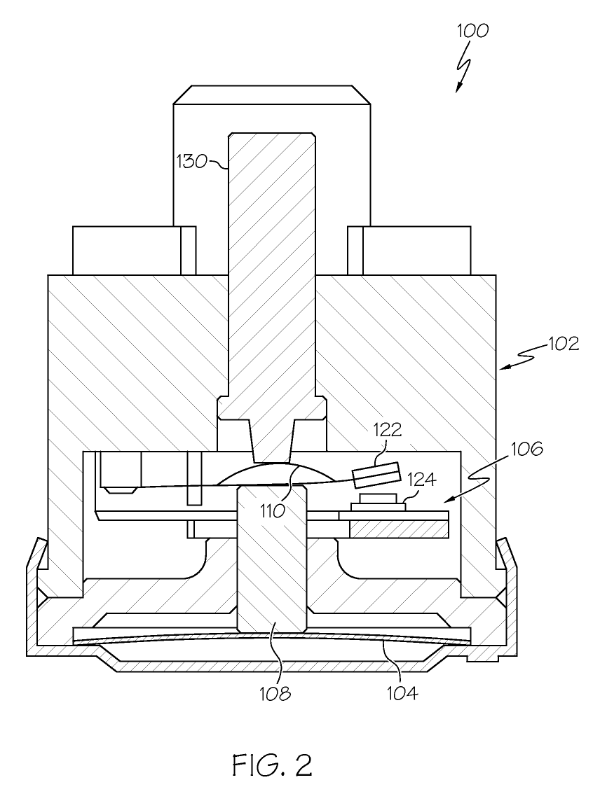

The temperature sensitive element 104 is responsive to temperature variations to selectively move between at least a first position and a second position. The temperature sensitive element 104 may be variously configured to implement this functionality, but in the depicted embodiment it is a bimetallic element. The bimetallic element 104 will move (or “snap”) from the first position, which is the position depicted in FIG. 1, to the second position, which is the position depicted in FIG. 2, when the bimetallic element 104 reaches a predetermined temperature set value. The bimetallic element 104 will then move back to the first position upon reaching a predetermined temperature reset value. As is generally known, the specific temperature set and reset values may be determined by material selection and shape. In the depicted embodiment, the bimetallic element 104 is disc-shaped.

The switch 106 is disposed within the housing inner volume 120, and is movable between a first switch position and a second switch position. Although the configuration of the switch 106 may vary, in the depicted embodiment it includes a movable contact 122 and a fixed contact 124. The switch 106 is additionally configured, at least in the depicted embodiment, such that when the switch 106 is in the first switch position, which is the position depicted in FIG. 1, the movable contact 122 is electrically connected to the fixed contact 124. Conversely, when the switch 106 is in the second position, which is the position depicted in FIG. 2, the movable contact 122 is electrically isolated from the fixed contact 124. It will be appreciated that this is merely exemplary of one embodiment, and that in other embodiments the movable contact 122 could be electrically isolated from the fixed contact 124 when the switch is in the second position, and electrically connected to the fixed contact 124 when the switch is in the first position.

The movable contact 122 and the fixed contact 124 are both coupled to the housing 102, and more particularly to the base 112, via suitable fasteners 126 (only one visible). The fasteners 126 may be, for example, screws or rivets. The movable contact 122 and fixed contact 124 are also electrically connected to one or more terminals that are used to electrically connect the thermostat 100 to various other external systems. No matter the specific configuration of the switch 106, it is moved from the first position to the second position via the transfer pin 108.

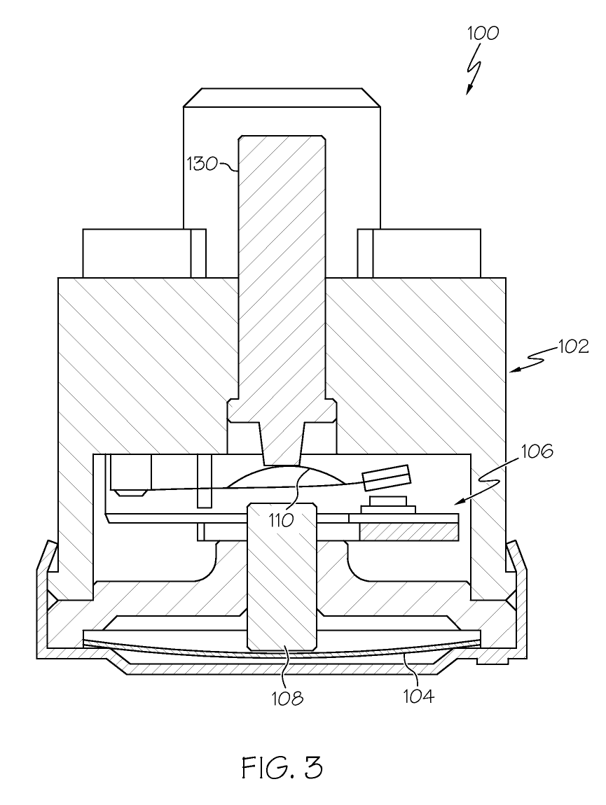

The transfer pin 108 is disposed between the temperature sensitive element 104 and the switch 106 and is movable with the temperature sensitive element 104. The transfer pin 108 extends through a transfer pin opening 128 that is formed through the retainer 116, and is configured to selectively move the switch 106 from the first position to the second position. More specifically, the transfer pin 108, upon movement of the temperature sensitive element 104 from the first position to the second position, supplies a force to the switch 106 that moves the switch 106 from the first switch position to the second switch position. The force that moves the switch 106 to the second switch position will be removed from the switch 106 when the temperature of the temperature sensitive element 104 falls below its temperature reset value, and the temperature sensitive element 104 moves back to its first position. However, as FIG. 3 depicts, the switch 106 will remain in the second switch position. This is because of the spring 110.

The spring 110 is coupled to the switch 106 and is configured to selectively supply at least a first retainer force to the switch 106 when the switch 106 is in the second switch position. This first retainer force, as was just alluded to, retains the switch 106 in the second switch position when the temperature sensitive element 104 moves from its second position back to its first position. In the depicted embodiment, the spring 110 is additionally configured to selectively supply a second retainer force to the switch 106 when the switch 106 is in the first position.

It will be appreciated that the spring 110 may be variously configured and implemented, but in the depicted embodiment the spring 110 comprises a C-spring that is movable between a first spring position and a second spring position. In the first spring position, which is the position depicted in FIG. 1, the C-spring 110 engages the transfer pin 108 and supplies the second retainer force to the switch 106. In the second spring position, which is the position depicted in FIGS. 2 and 3, the C-spring 110 engages a reset pin 130 and supplies the first retainer force to the switch 106.

In order to reset the thermostat 100, which in the depicted embodiment means moving the switch 106 back to the first switch position, the thermostat 100 requires an external, preferably manual, input force. In the depicted embodiment, this manual input force is preferably supplied to the reset pin 130. The reset pin 130 is pin disposed in, and extends from, the housing 102. More specifically, the reset pin 130 extends through a reset pin opening 132 that is formed in the base 112, and is configured to receive the external reset force from a user. The reset pin 130 additionally engages at least a portion of the switch 106, and is movable between a first pin position, which is the position depicted in FIGS. 1 and 3, and a second pin position, which is the position depicted in FIG. 2.

As may be appreciated from much of the preceding description of the thermostat 100, the reset pin 130 is moved from the first pin position (FIG. 1) to the second pin position (FIG. 2) when the switch 106 moves from the first switch position to the second switch position. The reset pin 130 is moved from the second pin position back to the first pin position only when an external reset force is supplied thereto. When the external force is of a magnitude sufficient to overcome the first retainer force supplied from the spring 110 to the switch 106, the reset pin 130 will move back to the first pin position. As FIG. 1 further depicts, the reset pin 130 will also move the switch 106 back to the first switch position, and reconfigure the spring 110 to supply the second retainer force to the switch 106.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A thermostat, comprising:
a housing;
a temperature sensitive element disposed within the housing and responsive to temperature variations to selectively move between at least a first position and a second position;
a switch disposed within the housing and movable between a first switch position and a second switch position;
a transfer pin disposed between the temperature sensitive element and the switch and movable with the temperature sensitive element, the transfer pin configured, upon movement of the temperature sensitive element from the first position to the second position, to supply a force to the switch that moves the switch from the first switch position to the second switch position; and
a spring coupled to the switch, the spring and configured to selectively supply at least a first retainer force to the switch when the switch is in the second switch position, the first retainer force retaining the switch in the second switch position when the temperature sensitive element moves from the second position back to the first position.

2. The thermostat of claim 1, wherein:
the switch comprises a fixed contact and a movable contact;
the movable contact is electrically connected to the fixed contact when the switch is in the first switch position; and
the movable contact is electrically isolated from the fixed contact when the switch is in the second switch position.

3. The thermostat of claim 1, wherein the spring is further configured to selectively supply a second retainer force to the movable contact when the switch is in the first position.

4. The thermostat of claim 1, wherein the spring comprises a C-spring.

5. The thermostat of claim 1, further comprising:
a reset pin disposed in, and extending from, the housing, the reset pin movable between a first pin position and a second pin position,
wherein:
the reset pin is moved from the first pin position to the second pin position when the switch moves from the first switch position to the second switch position, and
the reset pin is moved from the second pin position to the first pin position upon receipt of an external reset force.

6. The thermostat of claim 5, wherein the reset pin is configured to receive the external reset force from a user.

7. The thermostat of claim 5, wherein the housing comprises:
a base;
an end cap coupled to the base; and
a retainer coupled between the base and the end cap, the retainer retaining the temperature sensitive element within the housing.

8. The thermostat of claim 7, wherein:
the base includes a reset pin opening;
the retainer includes a transfer pin opening;
the reset pin extends through the reset pin opening; and
the transfer pin extends through the transfer pin opening.

9. The thermostat of claim 1, wherein the temperature sensitive element comprises a bimetallic element.

10. The thermostat of claim 9, wherein the bimetallic element comprises a bimetal disc.

11. A thermostat, comprising:
a housing;
a reset pin disposed in, and extending from, the housing, the reset pin movable between a first pin position and a second pin position;
a temperature sensitive element disposed within the housing and responsive to temperature variations to selectively move between at least a first position and a second position;
a switch disposed within the housing and including a fixed contact and a movable contact, the movable contact movable between a closed position, in which the movable contact is electrically connected to the fixed contact, and an open position, in which the movable contact is electrically isolated from the fixed contact;
a transfer pin disposed between the temperature sensitive element and the switch and movable with the temperature sensitive element, the transfer pin configured, upon movement of the temperature sensitive element from the first position to the second position, to supply a force to the movable contact that moves the movable contact from the closed position to the open position; and
a C-spring coupled to the movable contact and configured to selectively supply at least a first retainer force to the movable contact when the movable contact is in the open position, the first retainer force retaining the movable contact in the open position when the temperature sensitive element moves from the second position back to the first position,
wherein:
the reset pin is moved from the first pin position to the second pin position when the switch moves from the closed position to the open position, and
the reset pin is moved from the second pin position to the first pin position upon receipt of an external reset force.

12. The thermostat of claim 11, wherein the C-spring is further configured to selectively supply a second retainer force to the movable contact when the movable contact is in the closed position.

13. The thermostat of claim 11, wherein the reset pin is configured to receive the external reset force from a user.

14. The thermostat of claim 11, wherein the temperature sensitive element comprises a bimetallic element.

15. The thermostat of claim 14, wherein the bimetallic element comprises a bimetal disc.

16. The thermostat of claim 11, wherein the housing comprises:
a base;
an end cap coupled to the base; and
a retainer coupled between the base and the end cap, the retainer retaining the temperature sensitive element within the housing.

17. The thermostat of claim 16, wherein:
the base includes a reset pin opening;
the retainer includes a transfer pin opening;
the reset pin extends through the reset pin opening; and
the transfer pin extends through the transfer pin opening.

18. The thermostat of claim 11, wherein the fixed contact and the movable contact are each coupled to the base.

19. A thermostat, comprising:
a housing;
a reset pin disposed in, and extending from, the housing, the reset pin movable between a first pin position and a second pin position;
a bimetallic element disposed within the housing and responsive to temperature variations to selectively move between at least a first position and a second position;
a switch disposed within the housing and movable between a first switch position and a second switch position;
a transfer pin disposed between the bimetallic element and the switch and movable with the temperature sensitive element, the transfer pin configured, upon movement of the temperature sensitive element from the first position to the second position, to supply a force to the switch that moves the switch from the first switch position to the second switch position; and
a C-spring coupled to the switch and configured to selectively supply at least a first retainer force to the switch when the switch is in the second switch position, the first retainer force retaining the switch in the second switch position when the temperature sensitive element moves from the second position back to the first position,
wherein:
the reset pin is moved from the first pin position to the second pin position when the switch moves from the first switch position to the second switch position, and
the reset pin is moved from the second pin position to the first pin position upon receipt of an external reset force.

20. The thermostat of claim 19, wherein:
the switch comprises a fixed contact and a movable contact;
the movable contact is electrically connected to the fixed contact when the switch is in the first switch position; and
the movable contact is electrically isolated from the fixed contact when the switch is in the second switch position.
